(19) United States
(12) Patent Application Publication
(10) Pub. No.: US 2025/0168589 A1
(43) Pub. Date: May 22, 2025

(54) METHOD AND DEVICE FOR DETERMINING A LOCATION OF A MOBILE DEVICE

(71) Applicant: GRABTAXI HOLDINGS PTE. LTD., Singapore (SG)

(72) Inventors: Vibhuti Dineshkumar VADGAMA, Singapore (SG); Mei LENG, Singapore (SG)

(21) Appl. No.: 18/724,896

(22) PCT Filed: Dec. 27, 2022
(86) PCT No.: PCT/SG2022/050932

§ 371 Date: Jun. 27, 2024

(30) Foreign Application Priority Data
Dec. 29, 2021 (SG) 10202114480S

(51) Int. Cl. H04W 4/02; G06N 3/08

(52) U.S. Cl. CPC H04W 4/02; G06N 3/08

(57) ABSTRACT

Aspects concern a method for determining a location of a mobile device comprising, for each order of a transport or transport-related service, wherein the order is made by means of a respective mobile terminal, generating a training data element from a wireless radio fingerprint observed by the respective mobile terminal at the time of the order and a location of the order, training a machine learning model with the training data elements by using the wireless radio fingerprints as inputs and the respective locations as ground truth and determining the location of a mobile device by acquiring a wireless radio fingerprint observed by the mobile device and feeding the wireless radio fingerprint to the trained machine learning model.

### TECHNICAL FIELD

Various aspects of this disclosure relate to methods and devices for determining a location of a mobile device, e.g. a mobile (communication) terminal.

### BACKGROUND

Many transport system services, in particular e-hailing and deliveries, rely on the highly accurate determination of the location of users. Service performance may suffer significantly if accuracy of localization is poor which may, however, occur when using Global Positioning System (GPS) for localization of the user by the user's mobile terminal, e.g. when the user is indoor or there is poor reception of GPS signals in urban canyons due to other reasons. Moreover, the accuracy of GPS-based localization not only depends on the mobile terminal's (e.g. smartphone's) environments but also on the quality of the mobile terminal as well as phone many other factors like weather and response time.

Accordingly, approaches for reliable mobile terminal localization are desirable.

### SUMMARY

Various embodiments concern a method for determining a location of a mobile device comprising, for each order (or location interaction) of a service (e.g. a transport service or a transport-related service delivery or a payment), wherein the order is made by means of a respective mobile terminal, generating a training data element from a wireless radio fingerprint (also referred to as wireless signal (or signals) fingerprint or pattern) observed by the respective mobile terminal at the time of the order (i.e. order interaction or location interaction which can be associated with such event for example creation of location) and a location of the order (e.g. a closest point of interest or for example a pickup location chosen by the user), training a machine learning model with the training data elements by using the wireless radio fingerprints as inputs and the respective locations (to the respective users) as ground truth (to eliminate need of field survey for ground truth collection) and determining the location of a mobile device by acquiring a wireless radio fingerprint observed by the mobile device and feeding the wireless radio fingerprint to the trained machine learning model.

According to one embodiment, the method further comprises getting, for at least some of the training data elements, an estimate of the mobile terminal's location by means of Global Positioning System and evaluating the trained machine learning model by comparing, for the at least some training data elements, the estimate of the mobile terminal's location and a location prediction for by the mobile terminal by the machine learning model.

According to one embodiment, the method comprises continuing training of the machine learning model depending on the evaluation.

According to one embodiment, the machine learning model is a neural network.

According to one embodiment, each training data element comprises additional machine learning model input data related to the respective mobile terminal, comprising at least one of an indication of a time when the respective mobile terminal has observed the wireless radio (e.g. either or a combination of WiFi and Bluetooth information) fingerprint and information about the mobile terminal and wherein the location of the mobile device is determined by feeding corresponding input data related to the mobile device to the machine learning model.

According to one embodiment, the method comprises, using the trained neural network, providing localization for a further service or a set of further (e.g. location-dependent) services.

According to one embodiment, the service and the further service may include but are not limited to a transport, delivery, shopping, advertising, payment or other location-dependent service.

According to one embodiment, the method comprises evaluating a performance difference between the further service when being provided with localization by the neural network and the service when using Global Positioning System-based localization. One such example is accuracy of point-of-interest prediction.

According to one embodiment, the method comprises performing the further service by using localization by the neural network depending on the result of the evaluation of the performance difference.

According to one embodiment, the neural network is trained to provide a latitude and a longitude and/or a geohash from its input.

According to one embodiment, a localization server is provided configured to perform one of the methods described above.

According to one embodiment, a computer program element is provided including program instructions, which, when executed by one or more processors, cause the one or more processors to perform one of the methods described above.

According to one embodiment, a computer-readable medium is provided including program instructions, which, when executed by one or more processors, cause the one or more processors to perform one of the methods described above.

It should be noted that embodiments described in context of one or the methods are analogously valid for the other method and the transport system controller.

### BRIEF DESCRIPTION OF THE DRAWINGS

The invention will be better understood with reference to the detailed description when considered in conjunction with the non-limiting examples and the accompanying drawings, in which:

FIG. 1 shows a communication arrangement for usage of an e-hailing or related service including a smartphone and a server.

FIG. 2 shows a flow diagram illustrating a method for training and evaluating a neural network-based localization.

FIG. 3 shows a system diagram illustrating an architecture for determining a location of a mobile terminal from a wireless radio fingerprint.

FIG. 4 shows a flow diagram illustrating a method for determining a location of a mobile device.

FIG. 5 shows a localization server according to an embodiment.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized and structural, and logical changes may be made without departing from the scope of the disclosure. The various embodiments are not necessarily mutually exclusive, as some embodiments can be combined with one or more other embodiments to form new embodiments.

Embodiments described in the context of one of the devices or methods are analogously valid for the other devices or methods. Similarly, embodiments described in the context of a device are analogously valid for a vehicle or a method, and vice-versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

As used herein, the term “and/or” includes any and all combinations of one or more of the associated listed items.

In the following, embodiments will be described in detail.

In the following, an example is given for e-hailing. It should be noted that embodiments may also be applied to other services where a user gives an order from his or her mobile terminal at a certain location, e.g. orders for any kind of transport service or transport-related service such as food or parcel delivery, shopping order fulfilment but also mobile payment etc. or interactions with a location entity prior to make an order followed by a selection etc. E-hailing is only used as an example in the following.

An e-hailing app, typically used on a smartphone, allows its user to hail a taxi (or also a private driver) through his or her smartphone for a trip.

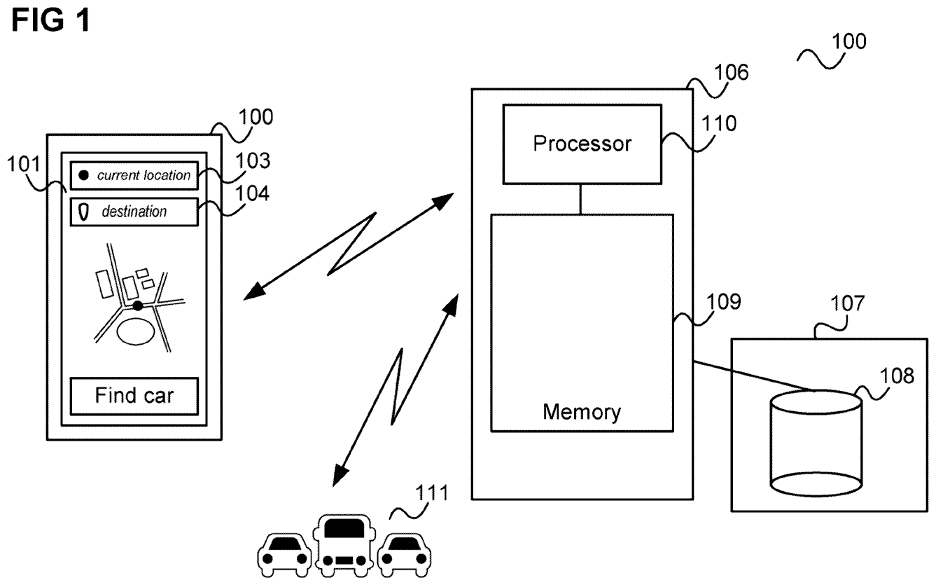

FIG. 1 shows a communication arrangement including a smartphone 100 and a server (computer) 106.

The smartphone 100 has a screen showing the graphical user interface (GUI) of an e-hailing (or similarly delivery, shopping, payment, advertising etc.) application that the smartphone's user has previously installed on his smartphone and has opened (i.e. started) to e-hail a ride (taxi or private driver) or to use any of other above mentioned services.

The GUI 101 includes a map 102 of the vicinity of the user's position (which the app may determine based on a location service, e.g. a GPS-based location service). Further, the GUI 101 includes a box for point of departure 103 (which may be set to the user's present location obtained from location service) and a box for destination 104 which the user may touch to enter a destination (e.g. opening a list of possible destinations). There may also be a menu (not shown) allowing the user to select various options, e.g. how to pay (cash, credit card, credit balance of the e-hailing service). When the user has selected a destination and made any necessary option selections, he or she may touch a “find car” button 105 to initiate searching of a suitable car.

For this, the e-hailing app communicates with the server 106 of the e-hailing service via a radio connection. The server 106 may consult a memory 109 or a data storage 108 having information about the current location of registered vehicles 111, about when they are expected to be free, about traffic jams etc. From this, a processor 110 of the server 106 selects the most suitable vehicle (if available, i.e. if the request can be fulfilled) and provides an estimate of the time when the driver will be there to pick up the user, a price of the ride and how long it will take to get to the destination. The server communicates this back to the smartphone 100 and the smartphone 100 displays this information on the GUI 101. The user may then accept (i.e. book) by touching a corresponding button. If the user accepts, the server 106 informs the selected vehicle 111 (or, equivalently, its driver), i.e. the vehicle the server 106 has allocated for fulfilling the transport request.

It should be noted that while the server 106 is described as a single server, its functionality, e.g. for providing an e-hailing service (or other service as mentioned above) for a whole city, will in practical application typically be provided by an arrangement of multiple server computers (e.g. implementing a cloud service). Accordingly, the functionality described in the following provided by the server 106 may be understood to be provided by an arrangement of servers or server computers.

The data storage 108 may for example be part of a cloud-based system 107 provided by a cloud storage provider to store and access data which it may use for taking decisions, such as information about the location of passengers, drivers and vehicles, their history (earlier orders and routes taken) etc.

The server 106 needs the location of the user (or equivalently, the location of the mobile terminal 100), e.g. for properly displaying the map 102, suggesting closest point-of-interest locations (e.g. for pick-up or receiving a delivery), estimating the time the user takes to reach a pick-up location etc. A typical approach to determine a mobile terminal's location is using the Global Positioning System (GPS), i.e. using a terminal localization service which uses a GPS receiver of the mobile terminal. However, a mobile terminal location determined in this manner may be of low accuracy, especially for indoor scenarios and urban areas with limited sky view due to line-of-sight.

In the following, embodiments are described for more reliable mobile terminal localization by using information about one or more wireless devices in the mobile terminal's vicinity, i.e., for example, so-called wireless fingerprinting, i.e. location estimation using wireless data (information about one or more wireless networks in the mobile terminal's vicinity).

Location estimation using wireless radio data may be done by obtaining ground-truth locations with associated wireless radio fingerprints (i.e. wireless radio data patterns) to build a mapping between location and observed wireless radio data pattern. However, in practice, at a geographically large scale in which an e-hailing service, for example, operates in, a field survey to gather this data is expensive and typically not feasible.

Therefore, according to various embodiments, order or interaction (creation) location data is used as ground truth. This means that a ground-truth for a user's location (for a wireless radio fingerprint observed by the user's mobile terminal 100 at the time of a order) is the location where the user has made the order or which the user choose for the order, e.g. the user's closest point-of-interest chosen for the order. The order may be a order for a transport of the user but also for other transport tasks like a parcel, food, etc. (i.e. for other vertical service orders). Thus, it is assumed that the user is near the chosen point-of-interest location for the order (e.g. chosen for the pick-up) when the user makes the order.

Thus, the localization of a user is estimating a point-of-interest location of the user using the user's wireless radio pattern (i.e. the WiFi pattern observed by the user's mobile terminal). In the terminology of machine learning, for each training sample, there is the wireless radio pattern (e.g. wireless device BSSID (Basic Service Set Identifier), wireless device RSSI (Received Signal Strength Indicator)), time information, device information and connectivity information for each of the identifier as input, and the machine learning model (e.g. neural network) solves a regression problem to get a (latitude, longitude) estimation of the user's location. This is achieved by using root mean squared error (RMSE) as primary loss metric to optimize the neural network during the training process along with mean absolute error (MAE) as secondary metric according to the below formulae.

$$MAE = \frac{1}{n} {\sum }_{j = 1}^{n} \vert {y}_{j} - \hat{{y}_{j}} \vert \\ RMSE = \sqrt{\frac{1}{n} {\sum }_{j = 1}^{n} {( {y}_{j} - \hat{{y}_{j}} )}^{2}}$$

Here the first term [symbol] ⱼ indicates user's predicted location while the second term [symbol] ⱼ indicates the respective ground truth label obtained from the training data.

According to various embodiments, the input comprises a categorical embedding to capture a wireless radio pattern of a particular location (namely BSSID information) combined with normalised signal strength (RSSI) to indicate weights of each BSSID corresponding to observed signal strength. This provides an efficient fingerprinting approach and enables the usage of a deep learning-based approach for fine tuning to achieve high localization accuracy. During serving (i.e. inference), the query location fingerprint is converted into the same representation for similarity calculation with observed training elements whose state is stored as trained weights of neural network.

The server 106 may use the user location determined in this manner (e.g. by implementation of a neural network) to correct (e.g. replace) a location of the user determined using GPS. It may then use this corrected (GPS) location for a respective service (e.g. for operation of the e-hailing service, e.g. for estimating a time of arrival of a driver at the user's location etc.) and may measure a performance improvement which has been achieved by correcting the GPS locations by using the wireless radio fingerprint-based localization. Depending on the measured performance, it may then decide whether to use GPS locations or wireless radio fingerprint-based locations for the service.

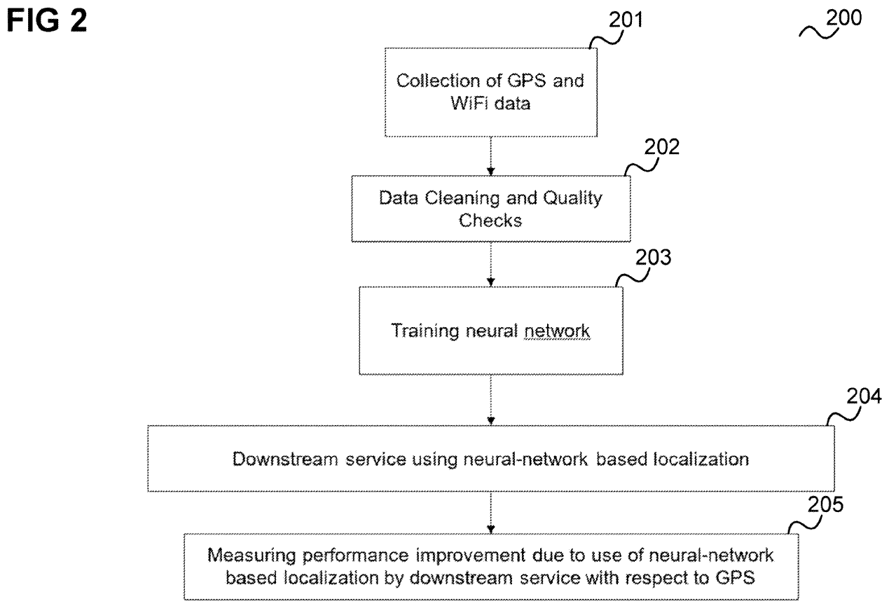

FIG. 2 shows a flow diagram 200 illustrating the complete procedure outlined above.

In 201, the server 106 (e.g. of an e-hailing service like in FIG. 1 but possibly also of another service) collects GPS and wireless radio data.

This for example involves utilizing an e-hailing service's event data pushed by an e-hailing service front-end application which includes wireless radio information when a user makes a order.

An example sample of wireless radio data for one access point included is for example:

The wireless radio data collected for a order (and/or payment) is associated with the location of the order (e.g. the point of interest location closest to the user chosen for the service or where the user makes the order) and/or payment (which is the localization ground truth) or while collecting information (verification or image) about a point-of-interest location. Further, the user's GPS location is determined. This is later used for evaluation by comparing the difference between the former and the later for determining quality of correction.

In 202, the server 106 performs data cleaning and quality checks.

This includes that only samples (wireless radio data+order location+GPS location) are used for training where the GPS location accuracy is high.

Further, samples are removed which include a wireless device BSSID which only occurs in one sample during a given sampling period (e.g. one or several days).

Additionally, samples are removed which include wireless device BSSID outliers. These include generic BSSTDs (e.g. a static WiFi with bssid==‘00:00:00:00:00:00’), a BSSID observed in a orders that a user has performed for another user (which may be detected based on a distance criterion which defines a radius for the BSSID: when the distance between order location (from GPS) and closest point-of-interest location is very high this can be suspected as an order for another) and hot-spot WiFi BSSIDs (i.e. personal WiFi devices which can appear at different geographic location considering possibility of device movement).

The remaining samples are used for training and evaluation.

In 203, the server 106 trains and evaluates the localization model (neural network) using the (remaining) samples (collected for past orders in 201, e.g. for a certain area or region, and cleaned in 202).

As explained above, the input data for the neural network (for one sample) comprises an embedding of the sample's BSSID concatenated with the (normalized) RSSI of the sample. The input data may further include one or more of an indication of the time the sample was collected (e.g. embedding of hour, embedding of day of the week) and embedding of connectivity information (whether the device number k is connected or not), an embedding of a frequency of the wireless device and embeddings of mobile terminal information (e.g. type, operating system, etc.).

In the following, exemplary embeddings are given:

| | 0 | 1 | 2 | 3 | 4 |
|---|---|---|---|---|---|
| bssid_00 | 217.0 | 94.0 | 3349.0 | 7019.0 | 880.0 |
| bssid_01 | 229.0 | 81.0 | 4075.0 | 6913.0 | 599.0 |
| bssid_02 | 376.0 | 575.0 | 3328.0 | 4726.0 | 268.0 |
| bssid_03 | 2485.0 | 641.0 | 4326.0 | 4312.0 | 2938.0 |
| bssid_04 | 137.0 | 21.0 | 5888.0 | 4727.0 | 1698.0 |
| bssid_05 | 791.0 | 256.0 | 3632.0 | 8527.0 | 416.0 |
| bssid_06 | 963.0 | 11.0 | 5522.0 | 6266.0 | 755.0 |
| bssid_07 | 291.0 | 274.0 | 3634.0 | 3930.0 | 531.0 |
| bssid_08 | 805.0 | 101.0 | 6292.0 | 5658.0 | 754.0 |
| bssid_09 | 194.0 | 12.0 | 1607.0 | 6495.0 | 931.0 |
| bssid_10 | 257.0 | 263.0 | 3208.0 | 6949.0 | 2070.0 |
| bssid_11 | 215.0 | 1071.0 | 982.0 | 1125.0 | 131.0 |
| bssid_12 | 633.0 | 314.0 | 3214.0 | 901.0 | 1082.0 |
| bssid_13 | 931.0 | 333.0 | 943.0 | 2897.0 | 1185.0 |
| bssid_14 | 453.0 | 2570.0 | 4855.0 | 5657.0 | 1093.0 |
| bssid_15 | 380.0 | 855.0 | 925.0 | 5392.0 | 148.0 |
| bssid_16 | 913.0 | 331.0 | 616.0 | 5751.0 | 147.0 |
| bssid_17 | 179.0 | 176.0 | 0.0 | 8153.0 | 2622.0 |
| bssid_18 | 658.0 | 390.0 | 0.0 | 4437.0 | 105.0 |
| bssid_19 | 912.0 | 93.0 | 0.0 | 5653.0 | 106.0 |
| rssi_00 | −68.0 | −54.0 | −78.0 | −62.0 | −71.0 |
| rssi_01 | −73.0 | −55.0 | −78.0 | −62.0 | −71.0 |
| rssi_02 | −74.0 | −58.0 | −78.0 | −63.0 | −74.0 |
| rssi_03 | −79.0 | −60.0 | −81.0 | −63.0 | −74.0 |
| rssi_04 | −83.0 | −60.0 | −81.0 | −64.0 | −77.0 |
| rssi_05 | −84.0 | −61.0 | −81.0 | −69.0 | −77.0 |
| rssi_06 | −84.0 | −61.0 | −82.0 | −70.0 | −79.0 |
| rssi_07 | −84.0 | −62.0 | −82.0 | −70.0 | −79.0 |
| rssi_08 | −84.0 | −63.0 | −86.0 | −70.0 | −79.0 |
| rssi_09 | −84.0 | −63.0 | −87.0 | −71.0 | −80.0 |
| rssi_10 | −87.0 | −63.0 | −89.0 | −72.0 | −80.0 |
| rssi_11 | −87.0 | −63.0 | −89.0 | −74.0 | −80.0 |
| rssi_12 | −87.0 | −64.0 | −90.0 | −75.0 | −80.0 |
| rssi_13 | −88.0 | −64.0 | −90.0 | −75.0 | −80.0 |
| rssi_14 | −88.0 | −65.0 | −90.0 | −75.0 | −81.0 |
| rssi_15 | −88.0 | −66.0 | −91.0 | −76.0 | −81.0 |
| rssi_16 | −88.0 | −66.0 | −91.0 | −76.0 | −81.0 |
| rssi_17 | −89.0 | −67.0 | 0.0 | −76.0 | −81.0 |
| rssi_18 | −89.0 | −67.0 | 0.0 | −76.0 | −81.0 |
| rssi_19 | −89.0 | −68.0 | 0.0 | −76.0 | −81.0 |
| Freq_00 | 2437.0 | 5240.0 | 5245.0 | 2439.0 | 2450.0 |
| Freq_01 | 5240.0 | 2450.0 | 2437.0 | 2450.0 | 2440.0 |
| . | . | . | . | . | . |
| Freq_19 | 5245.0 | 2439.0 | 5240.0 | 5240.0 | 5245.0 |
| is_connected_id | 0.0 | 2.0 | 1.0 | 3.0 | 0.0 |
| os_type | 1 | 1 | 1 | 1 | 1 |
| device_brand | 3.0 | 7.0 | 5.0 | 9.0 | 2.0 |
| hour | 12.0 | 19.0 | 7.0 | 12.0 | 16.0 |
| wifi_count | 28.0 | 30.0 | 17.0 | 30.0 | 30.0 |
| day_of_week | 6.0 | 6.0 | 6.0 | 6.0 | 6.0 |

Each column is one input data sample comprising of the top k BSSIDs (here k=19) and their respective RSSI values and values for further features (as mentioned above). A concatenation of all features values (i.e. the values of one column) is input to the neural network. This step tries to identify which of the IDs are matching between input query and observed set present in the dictionary (i.e. in the collected ground truth data).

The parameter “wifi_count” is not part of the input sample, just an indicator of number of non-zero strength wireless IDs (out of top k how many are present).

The ground truth (labels) for the (supervised) training are the locations of the orders (e.g. closest point-of-interest locations) or locations verified by user activity. The locations are given by latitude and longitude which are known for the pick-up locations for example from map data.

After training, the server 106 evaluates the trained neural network using the GPS locations of the samples: The neural network output is in the form of a predicted user latitude and a predicted user longitude (which are, as explained above, learned from POI (point of interest locations), however, so may be different, even in case of perfect prediction, from the true user location). The server 106 may evaluate it by comparing the output for a sample with the GPS location of the sample, wherein it may take into account the GPS accuracy for filtering purpose prior to training (which may also be recorded as part of the sample). Examples are as follows

| | place_of_{—} | place_of_{—} | | | |
|---|---|---|---|---|---|
| | interest | interest | gps_{—} | user_{—} | user_{—} |
| | latitude | longitude | accuracy | latitude | longitude |
| 0 | 1.355502 | 103.988282 | 7.280 | 1.355163 | 103.988250 |
| 1 | 1.355502 | 103.988282 | 17.523 | 1.354665 | 103.988251 |
| 2 | 1.360881 | 103.990073 | 4.531 | 1.361052 | 103.990197 |
| 3 | 1.336840 | 103.982510 | 20.121 | 1.337624 | 103.982912 |
| 4 | 1.355950 | 103.988470 | 26.668 | 1.355781 | 103.988615 |

Depending on the evaluation, the server 106 may determine whether the neural network has been sufficiently trained or whether training should be continued (and e.g. further samples should be collected and corresponding training data elements generated).

In 204, the server 106 uses the trained neural network for localization for a certain service (i.e. a downstream consumer of the localization service based on the neural network trained in 203). The service may be any service from a business vertical including but not limited to transportation, delivery, shopping, payments, advertising and others, like for example point of interest identification. This service calls the (neural-network based) localization service to fetch corrected the user location, e.g. based on certain threshold conditions on OS based location accuracy not meeting standards (i.e. in case the GPS location's accuracy is not sufficient) and thus there is scope of correction relying on the (neural-network based) localization.

In 205, the server 106 may evaluate whether usage of the neural-network based localization leads to an improvement of the usage of GPS for localization. The server 106 may do this by checking results from downstream service using locations provided by the neural-network based localization with respect to results using GPS locations. As explained above, the neural network produces for example a (latitude, longitude) location value pair for an input which is expected to be enhanced in the sense of being close to the user's point-of-interest location (of the respective order). To verify the performance of replacing raw user GPS locations with the locations provided by the neural-network in downstream service the server 106 may perform the following:
1. train (neural network) model using data for an area (e.g. city) in a certain period of time.
2. apply the trained model on data in the weeks of the subsequent period for the area, and get the corrected location (i.e. obtained using the model) for each record.
3. get downstream service result for each record using raw user GPS location as input
4. get downstream service result for each record using corrected location as input
5. compare service results by measuring downstream service performance difference with respect to a primary metric for example accuracy of the downstream service along with distance error for user location in meters.

The neural network-based localization may be scaled to a wider area. This may be for example be done by extending the neural network architecture using an additional mechanism to identify geohash based on wireless radio data. Alternatively, neural networks for smaller areas may be trained and a simple interface may be provided which determines the closest location provided by one of the models to the user's location (e.g. GPS location). As another alternative, a simple machine learning module can be used as first layer to identify geohash and choose which of the smaller models to invoke based on identified geohash.

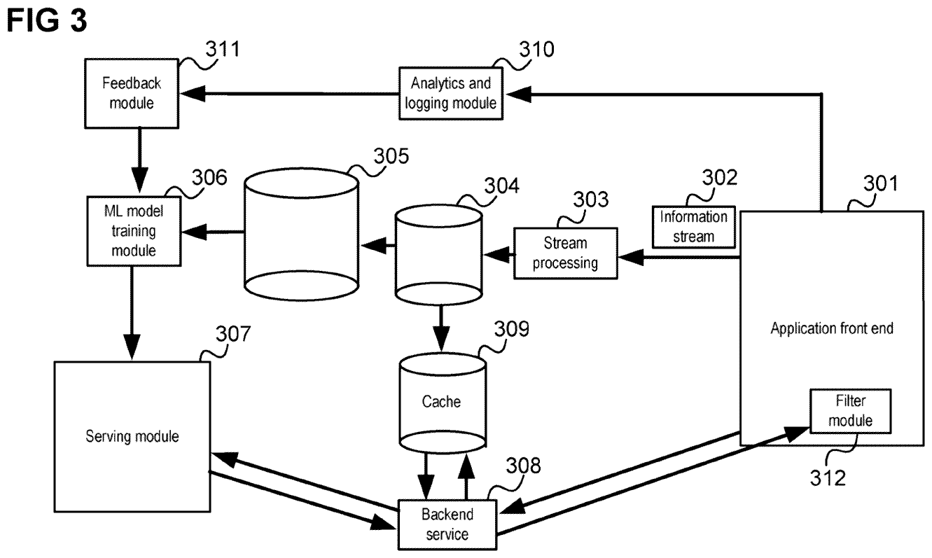

FIG. 3 shows a system diagram illustrating an architecture, e.g. implemented by the communication arrangement 100, for determining a location of a mobile terminal from a wireless radio fingerprint.

An application front-end 301 for the respective service provides a signal stream 302 specifying geographic point-of-interest locations in association with wireless radio fingerprints for different services (and thus different applications). A signal information stream processing module 303 processes the stream 302, i.e. extracts information from the stream, and stores the extracted information (locations and fingerprints per user) in a data storage 304. Using this information, training and test data for the ML model (neural network) are generated and stored in a training data storage 305.

A ML model training module 306 trains a neural network (or multiple neural networks, see alternative embodiments described above) provided by a serving module 307. Using the trained neural network or neural networks, the serving module responds to location queries from a backend service 308 which in turn responds to queries it has received from the application front end 301 (wherein the queries include wireless radio fingerprints). The application front end 301 comprises an application location filter logic module 312 which provides the locations provided by the backend service to downstream services (e.g. corresponding applications).

Associations between wireless radio fingerprints and locations may also be cached in a cache 309 for the backend service 308 to access to answer a query without having to consult the serving module 307).

The performance of the neural network and fingerprint-based localization may be evaluated via an analytics and logging module 310 and a feedback module 311. The ML model training module 306 may for example re-train the neural network (or neural networks) depending on feedback provided by the feedback module 311. The feedback module 311 may for example provide feedback based on user reactions provided from the application front end 301 which is analyzed and logged by the analytics and logging module 310. The feedback module 311 thus serves for automated improvement based on responses to the fingerprint-based localization.

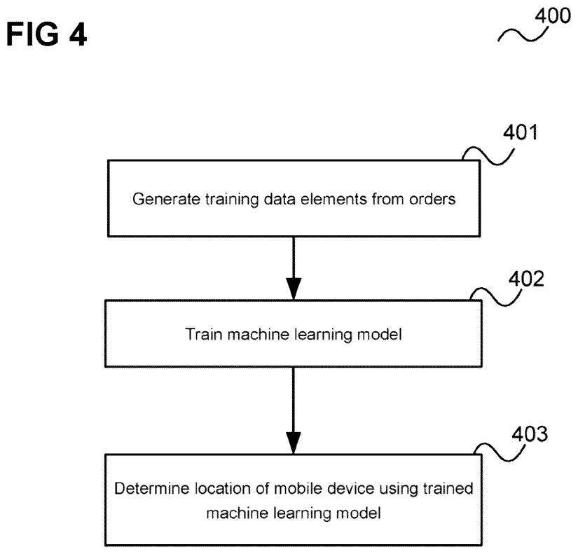

In summary, according to various embodiments, a method is provided as illustrated in FIG. 4.

FIG. 4 shows a flow diagram 400 illustrating a method for determining a location of a mobile device.

In 401, for each order of a transport service, wherein the order is made by means of a respective mobile terminal, a training data element is generated from a wireless radio fingerprint observed by the respective mobile terminal at the time of the order and a location of the order (e.g. a closest point of interest location of the order, e.g. to a pickup location or payment location, depending on the service; this may also include or be information about any location where a worker or merchant has performed an interaction to fulfil the order or while collecting data for particular location or point-of-interest).

In 402, a machine learning model is trained with the training data elements by using the wireless radio fingerprints as inputs and the respective locations as ground truth.

In 403, the location of a mobile device is determined by acquiring a wireless radio fingerprint observed by the mobile device and feeding the wireless radio fingerprint to the trained machine learning model.

According to various embodiments, in other words, locations of service orders (e.g. closest point-of-interest locations of orders for a transport, delivery, shopping or payment service) are used as ground truth for wireless radio fingerprints (i.e. wireless radio data patterns) for a machine learning (ML) model like a neural network. This eliminates the need of an extensive field survey to collect ground-truth data for acquiring ML training data which is costly and time consuming.

The wireless radio fingerprint, e.g. WiFi or Bluetooth information from a mobile device's neighbourhood is then used for determining the position of the mobile terminal. This may improve the accuracy of the location compared to a location determined GPS (also referred to as “GPS location”) and may thus be used instead of the GPS location, i.e. to correct the GPS location.

The model-based localization provided in this manner may be evaluated by comparing the performance of a (downstream) service using the localization service with its performance when using GPS localization.

It should be noted that the term transport service is not merely to be understood as a transport of passengers (i.e. a taxi or e-hailing service) but also includes transport of food and/or beverages (i.e. the transport service may be a food/beverage service) letters and parcels (i.e. may be a mail transport service). The service does not necessarily need to be a transport service but may for example also be a payments done at a merchant by a user etc and also any of the location interaction for example verification, confirmation or location information collection performed from the workers or merchant while fulfilling such requests.

The methods described herein may be performed and the various processing or computation units and the devices and computing entities described herein may be implemented by one or more circuits. In an embodiment, a “circuit” may be understood as any kind of a logic implementing entity, which may be hardware, software, firmware, or any combination thereof. Thus, in an embodiment, a “circuit” may be a hard-wired logic circuit or a programmable logic circuit such as a programmable processor, e.g. a microprocessor. A “circuit” may also be software being implemented or executed by a processor, e.g. any kind of computer program, e.g. a computer program using a virtual machine code. Any other kind of implementation of the respective functions which are described herein may also be understood as a “circuit” in accordance with an alternative embodiment.

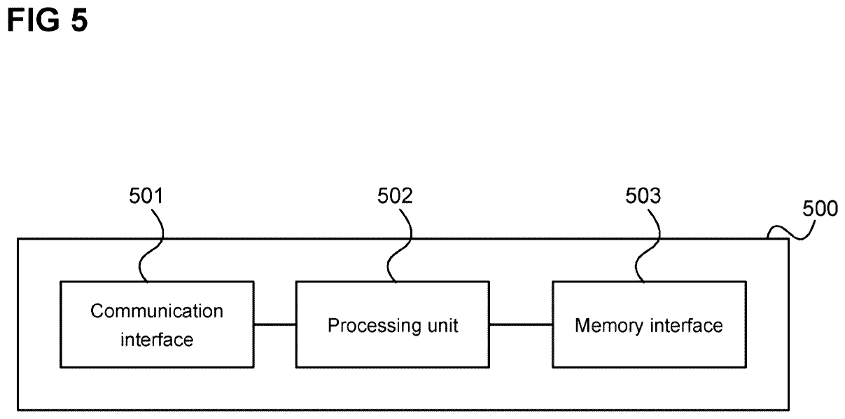

The method of FIG. 4 may for example be performed by a localization server as illustrated in FIG. 5.

FIG. 5 shows a localization server 500 according to an embodiment.

The localization server 500, e.g. implemented by a server computer, includes a communication interface 501 (e.g. configured to receive requests for localization, fingerprint information and closest point-of-interest-locations). The localization server 500 further includes a processing unit 502 and a memory 503. The memory 503 may be used by the processing unit 502 to store, for example, the training data and the trained neural network. The localization server 500 is configured to perform the method of FIG. 4. For example, the memory 503 stores program code which makes the localization server 500 perform the method of FIG. 4.

While the disclosure has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A method for determining a location of a mobile device comprising:
for each order of a service, wherein the order is made by means of a respective mobile terminal, generating a training data element from a wireless radio fingerprint observed by the respective mobile terminal at the time of the order and a location of the order; training a machine learning model with the training data elements by using the wireless radio fingerprints as inputs and the respective locations as ground truth; and determining the location of a mobile device by acquiring a wireless radio fingerprint observed by the mobile device and feeding the wireless radio fingerprint to the trained machine learning model.

2. The method of claim 1, further comprising getting, for at least some of the training data elements, an estimate of the mobile terminal's location by means of Global Positioning System and evaluating the trained machine learning model by comparing, for the at least some training data elements, the estimate of the mobile terminal's location and a location prediction for by the mobile terminal by the machine learning model.

3. The method of claim 2, comprising continuing training of the machine learning model depending on the evaluation.

4. The method of claim 1, wherein the machine learning model is a neural network.

5. The method of claim 1, wherein each training data element comprises additional machine learning model input data related to the respective mobile terminal, comprising at least one of an indication of a time when the respective mobile terminal has observed the wireless radio fingerprint and information about the mobile terminal and wherein the location of the mobile device is determined by feeding corresponding input data related to the mobile device to the machine learning model.

6. The method of claim 1, comprising, using the trained neural network, providing localization for a further service.

7. The method of claim 6, wherein the further service is one of transportation, delivery, shopping, payment and advertising.

8. The method of claim 1, comprising evaluating a performance difference between the further service when being provided with localization by the neural network and the service when using Global Positioning System-based localization.

9. The method of claim 8, comprising performing the further service by using localization by the neural network depending on the result of the evaluation of the performance difference.

10. The method of claim 1, wherein the neural network is trained to provide a latitude and a longitude and/or a geohash from its input.

11. A localization server configured to perform the method of claim 1.

12. A computer program element comprising program instructions, which, when executed by one or more processors, cause the one or more processors to perform the method of claim 1

13. A computer-readable medium comprising program instructions, which, when executed by one or more processors, cause the one or more processors to perform the method of claim 1.
